(19) United States
(12) Patent Application Publication
(10) Pub. No.: US 2022/0024126 A1
(43) Pub. Date: Jan. 27, 2022

(54) ADDITIVE MANUFACTURING PROCESS USING COLORANT AND LASER FUSION

(71) Applicant: Hewlett-Packard Development Company, L.P., Spring, TX (US)

(72) Inventors: Wei Huang, Palo Alto, CA (US); Gary J. Dispoto, Palo Alto, CA (US)

(73) Assignee: Hewlett-Packard Development Company, L.P., 10300 Energy Drive, TX (US)

(21) Appl. No.: 17/298,531

(22) PCT Filed: Apr. 17, 2019
(86) PCT No.: PCT/US2019/027854

§ 371 Date: May 28, 2021

(51) Int. Cl. B29C 64/188; B33Y 10/00; B33Y 30/00; B29C 64/153; B29C 64/268

(52) U.S. Cl. CPC B29C 64/188; B33Y 10/00; B29C 64/268; B29C 64/153; B33Y 30/00

(57) ABSTRACT

An apparatus, and related methods and machine readable programs are disclosed herein for additive manufacturing. An implementation of an apparatus includes a processor circuit, a first dispenser coupled to the processor circuit to deposit a sinterable material, a second dispenser coupled to the processor circuit to deposit colorant on the layer of sinterable material, and a laser coupled to the processor circuit to scan across and to selectively fuse the layer of sinterable material.

### BACKGROUND

Additive manufacturing processes (also referred to as “three-dimensional printing” processes) are often used to fabricate objects including three-dimensional objects. In an additive manufacturing process, a computer controls the spreading of material to form successive layers of material according to a digital model of an object. As the successive layers fuse to each other, a three-dimensional object is formed. Such processes may be used to fabricate a variety of three-dimensional objects, including functional and aesthetic machine components, consumer and industrial products that are produced in short runs, and customized high-value-products that may be one-of-a-kind.

### BRIEF DESCRIPTION OF FIGURES

Various examples may be more completely understood in consideration of the following detailed description in connection with the accompanying drawings, in which:

FIG. 1 illustrates a block diagram of a top view of an example system of the present disclosure;

FIG. 2 illustrates a flowchart of an example method for fabricating an object via an additive manufacturing process;

FIG. 3 illustrates an example slice image for use in fabricating an object having a predetermined color distribution; and

FIG. 4 depicts a high-level block diagram of an example computer that can be transformed into a machine capable of performing the functions described herein.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is by way of illustration, and not limitation.

### DETAILED DESCRIPTION

Aspects of the present disclosure are believed to be applicable to a variety of different types of apparatuses, systems and methods involving additive manufacturing. In certain implementations, aspects of the present disclosure can be beneficial when used in the context of fabricating a variety of objects (such as three-dimensional, two-dimensional, and 2.5 dimensional objects including surface finishings or coatings), including functional and aesthetic machine components, consumer and industrial products that are produced in short runs (such as less than one thousand units), and customized high-value products that may be one-of-a-kind. In some embodiments, an array of lasers can be used to fuse a layer of sinterable material. The material itself may be colored, or may be a neutral color, or be devoid of color (such as transparent or white). Colorant can be selectively applied during the manufacturing process to achieve a desired end result. While not necessarily so limited, various aspects may be appreciated through the following discussion of non-limiting examples which use exemplary contexts.

Accordingly, in the following description various specific details are set forth to describe specific examples presented herein. Other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element. Also, although aspects and features may in some cases be described in individual figures, it will be appreciated that features from one figure or embodiment may be combined with features of another figure or embodiment even though the combination is not explicitly shown or explicitly described as a combination.

In accordance with the disclosure, an apparatus is provided including a processor circuit, a first dispenser coupled to the processor circuit to deposit a layer of sinterable material, a second dispenser coupled to the processor circuit to deposit colorant on the layer of sinterable material, and a laser coupled to the processor circuit to scan across and to fuse the layer of sinterable material.

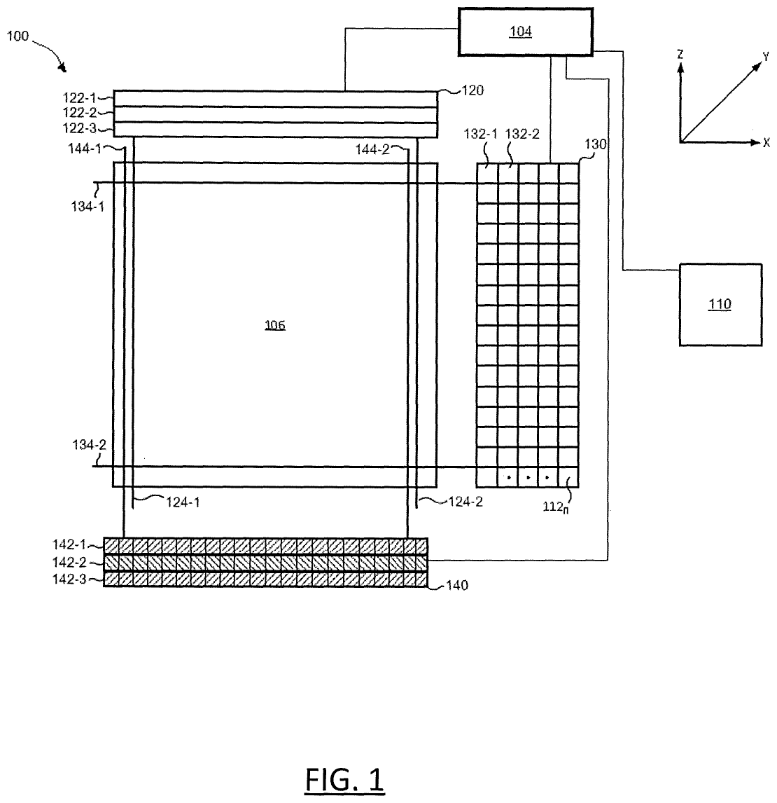

For purposes of illustration, and not limitation, FIG. 1 presents illustrates a block diagram of a top view of an apparatus 100 of the present disclosure. Apparatus 100 including a processor circuit 110 that may include a discrete print circuit 104. The processor circuit 110 and print circuit 104 work together to fabricate a three-dimensional object via selective addition of a material. System 100 further includes a first dispenser 120 coupled to the processor circuit 110 to deposit a layer 10 of sinterable material, a second dispenser 130 coupled to the processor circuit 110 to deposit colorant on the layer 10 of sinterable material, and a laser 140 coupled to the processor circuit 110 to scan across and to selectively fuse the layer 10 of sinterable material.

In one example, the processor circuit 110 includes a computing device (such as a general purpose computing device or a special purpose computing device) that stores a model of an object to be fabricated. The print circuit 104 can be integral to an additive manufacturing device (“3D” printer) that couples to the remainder of processor circuit 110 in a separate computing device.

In one example, the object is fabricated by the processor circuit and print circuit 104 in a series of layers that are fused together. Thus, the model of the object may include a plurality of cross sections or slice images that are reproduced by the print circuit 104 in sinterable material and printing fluid, where each slice image corresponds to a layer of the object. The processor circuit 110 may or may not include an application for generating and/or modifying the model.

The processor circuit 110 sends electronic signals to the print circuit 104. These electronic signals, in turn, drive the components of the print circuit 104 (discussed in further detail below) to cooperate to fabricate the object. Thus, the system illustrated in FIG. 1 shows one example configuration that may be used to implement the functionality of the processor circuit 110 and the print circuit 104.

In operation, a thin base layer of material (such as powder) is coated on a build bed 106 of the device 100 by first dispenser 120 moving in a first direction along the z dimension. The build bed defines a working area upon which the object is fabricated, and may define a substantially flat, planar space. Dispenser can include a material coater 120, such as a hopper, a blade and/or a roller to dispense and spread the sinterable material.

In one example, the first dispenser 120 may be moveable in at least two dimensions (or, along two axes of a three-dimensional coordinate plane). In the example illustrated in FIG. 1, the first dispenser 120 may be moveable along the z dimension (such as from top to bottom across the page of FIG. 1, or along the dimension parallel to the plane of the build bed 106) and along the y dimension (into the page of FIG. 1, or along the dimension perpendicular to the plane of the build bed 106). In this case, a first set of tracks 124-1 and 124-2 supports the first dispenser 120 for movement along the z dimension, while a second set of tracks (not shown) supports the first dispenser 120 for movement along the y dimension. Additionally or alternatively the build bed 106 may be moved along the y-dimension by mounting the build bed 106, for example, on a track or set of tracks (not shown), and the build bed may be moved along the y-dimension under the force of an actuator (not shown) that can include, for example, a motor coupled to the processor circuit 110, or a controllable valve coupled to a hydraulic piston that is coupled to the processor circuit 110.

For the powdered material any powder-based thermoplastic material can be used, including but not limited to PA 12, PA 11, PA 6, TPU, PP, and the like. Such thermoplastic materials can be reinforced by glass beads and fibers, or other materials. If desired, the powder can include a mixture of thermoplastic powder and powder of high melting temperature materials, such as metal and ceramic materials.

Depositing the sinterable material via dispenser 120 may be accomplished at a voxel level. The voxel level can be defined with reference to the spatial resolution of the dispenser 120. While one type of sinterable material may be deposited, the dispenser 120 may include a number of dispensers that deposit two or more kinds of sinterable material. For example, the sinterable material may be provided with colorant therein, or without colorant therein. For example, sinterable material can include material that is white in color or otherwise monochromatic (different shades of gray or off-white) in order to provide regions of the 3d object that are free of color.

Next, the second dispenser 130 is moved to an appropriate height (such as according to an object model file being printed via the processor circuit 110) along the y dimension, and then passes across the build bed 106 in a first direction along the x dimension. As the second dispenser 130 passes across the build bed 106, it lays down a colorant by way of ejecting printing fluid over at least a portion of the layer 10 of powder. The colorant may simply include a dye and/or a pigment suspended in an ink material. If desired, the second dispenser can include a detailing agent. Additionally or alternatively, the build bed 106 can be moved along the y-dimension as described above.

The second dispenser 130 includes a plurality of fluid ejection modules 132-1 to 132n (hereinafter collectively referred to as “fluid ejection modules 132”), each of which may be controlled by a respective fluid ejection module controller (not shown) that receives electronic signals from the processor circuit 110 (such as via the print circuit 104). Each fluid ejection module 132 may include a plurality of fluid ejection devices (dies, pens, nozzles, or the like) for ejecting printing fluid (dyes, inks containing suspended pigments, fusing agents, non-fusing agents, detailing agents). Fusing agents typically include fluids that cause a powder to fuse together or solidify when exposed to a quantity of energy, such as when being exposed to infrared light.

The fluid ejection devices may be of the type used in high-speed commercial inkjet printing presses. In one example, a first plurality of the fluid ejection devices ejects a first type of fluid, such as an ink including a first colorant, while a second plurality of the fluid ejection devices ejects a second type of fluid, such as a second ink, or other fluid. The non-fusing printing fluids may include cooling agents, agents that can chemically or physically prevent or weaken the fusing process, or agents that can break down the fused solid material after fusing. The non-fusing printing fluids may also include fluids that react differentially to subsequent finishing processes (ultrasound, shaking, application of specific gases, etc.). The deposited fluid(s) may be free of a fusing agent such that the fluids do not significantly affect the effect of the laser on the fusible material.

In one example, the second dispenser 130 may be moveable in at least two dimensions (or, along two axes of a three-dimensional coordinate plane). In the example illustrated in FIG. 1, the second dispenser 130 may be moveable along the x dimension (such as from left to right across the page of FIG. 1, or along the dimension parallel to the plane of the build bed 106) and along the y dimension (into the page of FIG. 1, or along the dimension perpendicular to the plane of the build bed 106). In this case, a first set of tracks 134-1 and 134-2 supports the second dispenser 130 for movement along the x dimension, while a second set of tracks (not shown) supports the second dispenser 130 for movement along the y dimension.

Depositing the colorant by way of the second dispenser 130 may be accomplished at a voxel level. The voxel, or three dimensional pixel relating to the deposition of colorant may be defined with respect to the resolution of the dispenser. For example, the voxel for defining coloration may correspond to the smallest surface area over an area of sinterable or sintered material that can be used to define a desired color by depositing droplets of a colorant or colorants. Thus, the system may be used, for example, in order to achieve a predetermined three dimensional color distribution in the three dimensional object that is being manufactured.

It is also possible to practice halftoning techniques (via droplet deposition) rather than simply depositing a layer of colorant. Halftoning is a reprographic technique that simulates continuous-tone imagery through the use of dots, varying either in size or in spacing, thus generating a gradient-like effect. Where continuous-tone imagery can contain an infinite range of colors or greys, the halftone process reduces visual reproductions to an image that is printed with one color of ink, in dots of differing size (pulse-width modulation) or spacing (frequency modulation) or both. When the halftone dots are small, the human eye interprets the patterned areas as if they were smooth tones.

It will be appreciated that halftoning can be practiced alone or with depositions of continuous layers of colorant material. Or, continuous layers of colorant material can be deposited over all or a part of a layer of sinterable or sintered material. Moreover, depositing the colorant may be accomplished in a selective manner based on a predetermined geometry of the three dimensional object to be formed. For example, colorant may be deposited near the surface of the object being made, or colorant may be distributed through an interior portion of the object being made.

The laser 140, which can include a single laser emitter, a row of laser emitters 142 or a two dimensional array of laser emitters on a translatable head (as depicted) is then moved to an appropriate height (according to an object model file, for example) along the y dimension, and then passes across the build bed 106 in a second direction (such as opposite the first direction) along the z dimension. As the laser 140 passes across the build bed, it emits intense, focused energy. Application of the energy to the first layer of sinterable material causes the sinterable material to absorb the energy and at least partially melt, which in turn causes at least some of the powder to fuse or solidify into a first layer of the object being made. The laser 140 can selectively emit pulses of laser light on a voxel by voxel basis to fuse all or a portion of the area that the laser 140 passes over. The voxel relating to the operation of the laser can be defined with reference to the width of its beam. It will be appreciated that this can be directly correlated to a volume in three dimensional space that is defined with reference to the horizontal layer, or slice of the object being made by the system 100 along the y direction as well as a grid defined by x and z coordinates. It will be appreciated that the colorant can be deposited on the layer of sinterable material before or after the sinterable material is fused by the laser, or concurrently with the fusion by the laser.

The laser 140 can include any desired type of laser of any suitable power output and wavelength range. While lasers in the infrared region may be used, using a laser with a shorter wavelength can be focused more precisely, whereby smaller structures at the part may be provided. An energetic IR laser (such as a CO₂ laser) may be used, for example. If desired, additional radiant heaters can be used to help sinter the material alongside the laser. By way of further example, Nd:YAG lasers, Yb-doped fiber lasers, and excimer lasers can also be used alone, or in combination with a CO₂ laser.

The system can then be configured to deposit further layers of sinterable material onto the first layer of the three-dimensional object, depositing colorant on the second layer of sinterable material, and fusing the second layer of sinterable material using the laser to form a second layer of the three dimensional object. In various implementations, the method may further include repeating the depositing of sinterable material, the depositing of colorant, and the fusing of sinterable material to form the three dimensional object.

As set forth above, the laser 140 may be moveable in at least two dimensions (or, along two axes of a three-dimensional coordinate plane). In the example illustrated in FIG. 1, the laser 140 is moveable along the z dimension (such as from top to bottom across the page of FIG. 1, or along the dimension parallel to the plane of the build bed 106 and perpendicular to the dimension along which the second dispenser 130 moves) and along the y dimension (into the page of FIG. 1, or along the dimension perpendicular to the plane of the build bed 106). In this case, a first set of tracks 144-1 and 144-2 supports the laser 140 for movement along the z dimension, while a second set of tracks (not shown) supports the laser 140 for movement along the y dimension. Additionally or alternatively, the build bed 106 can be moved along the y-dimension as described above.

The first dispenser 120, second dispenser 130 and the laser 140 may make subsequent passes, alternating as in the first pass, and reversing direction each time along the x and z dimensions, respectively. Each pass may also move the height of the first dispenser 120, second dispenser 130 and the laser 140 higher along the y dimension. Additionally or alternatively, the height of the build bed 106 along the y dimension can also be adjusted as described above. These subsequent passes fabricate additional layers of the object, which fuse to the prior layers, until the object is fully fabricated.

Implementations of the present disclosure may also be extended in all three dimensions. For instance, although examples of the present disclosure describe an additive manufacturing process based on slice images that are reconstructed in the x and z dimensions of the three-dimensional coordinate plane, entire images may also be fabricated along the y axis (i.e., in the build direction).

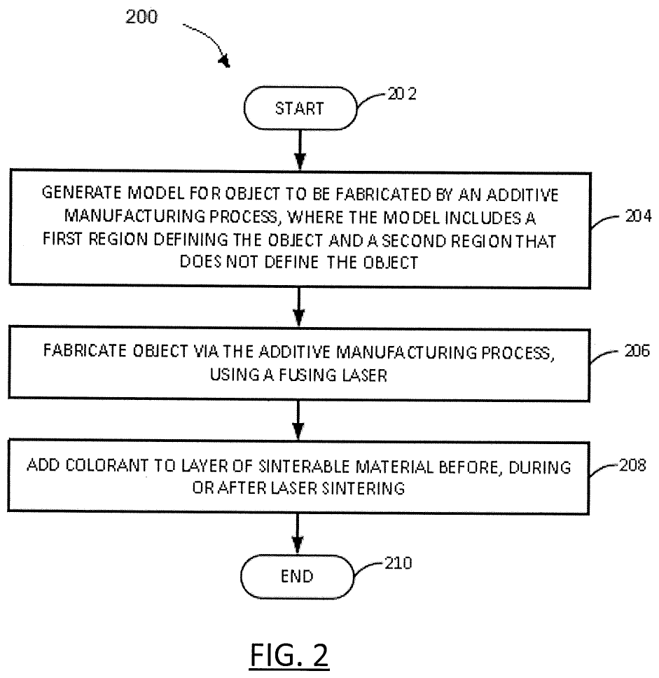

FIG. 2 illustrates a flowchart of an example method 200 for fabricating an object via an additive manufacturing process. The method 200 may be performed, for example, by the system 100 illustrated in FIG. 1. As such, reference is made in the discussion of FIG. 2 to various components of the system 100 to facilitate understanding. However, the method 200 is not limited to implementation with the system illustrated in FIG. 1.

The method 200 begins in block 202. In block 204, a model is generated (for example, using the processor circuit 110) for an item to be fabricated via an additive manufacturing process. As discussed above, the model may include a plurality of slice images, where each slice image corresponds to one layer of the object to be fabricated. Thus, each slice image may represent a cross section of the object. In one example, at least one of the slice images includes a first region and a second region. The first region of the slice image defines a portion of the layer of sinterable layer to be fused, while the second region of the slice image defines a portion of the layer that is not to be fused.

Referring back to FIG. 2, in block 206, the object is fabricated via the additive manufacturing process, using a fusing laser to render the object. As discussed above, the fusing laser 140 deposits energy on the sinterable material, which in turn raises the temperature of a sinterable material and causes the sinterable material to fuse together or solidify. In block 208, colorant is added to the layer of sinterable material, either before, after or during the fusion process. The method 200 ends in block 210.

It should be noted that although not explicitly specified, some of the blocks, functions, or operations of the methods 200 described above may include storing, displaying and/or outputting for a particular application. In other words, any data, records, fields, and/or intermediate results discussed in the method can be stored, displayed, and/or outputted to another device depending on the particular application. Furthermore, blocks, functions, or operations in FIGS. 2 that recite a determining operation, or involve a decision, do not necessarily imply that both branches of the determining operation are practiced.

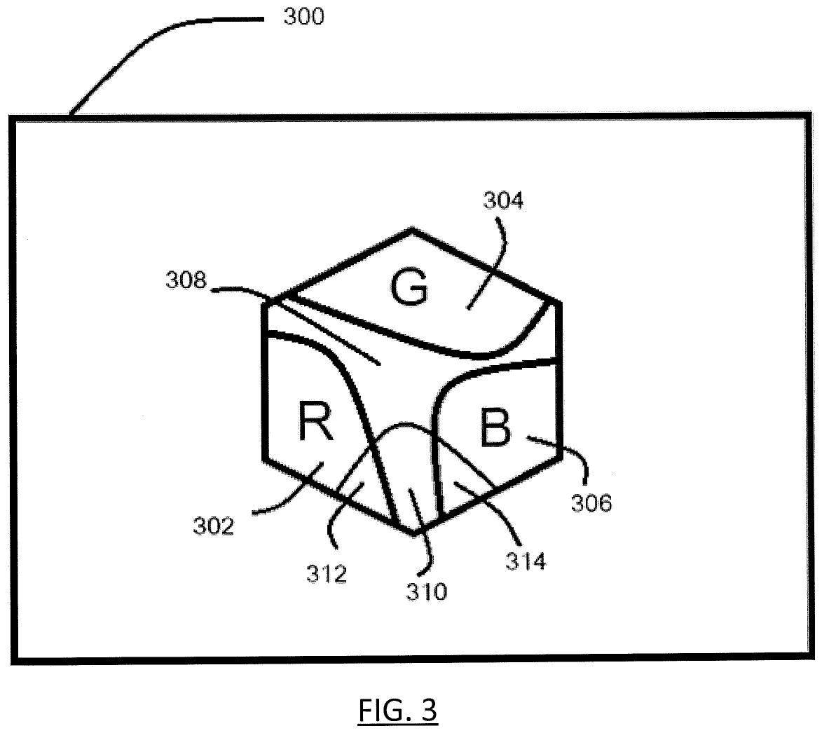

FIG. 3 illustrates an example slice image 300 for use in fabricating an object having a predetermined color distribution. As illustrated, the object (illustrated as having a hexagonal shape, for example) includes separate regions 302, 304, 306 to which the same or different colors can be applied (e.g., red, green blue). A remaining region 308 can be left uncolored, so that the color of the underlying material is present (e.g., white or the like). Some border regions 312, 314 are also provided that are overlaps between region 310/302 and 310/306 respectively. The system 100 can be configured to lay down different colored colorants in the various regions, and blend the colors in the overlapping regions. The colorant can be deposited via halftoning techniques or other suitable techniques. Moreover, the system 100 can be configured to fuse the area inside of the border of the hexagon with the laser, and not fuse the area outside of the hexagon. The colorant can be deposited before, after or concurrently with the laser fusing process.

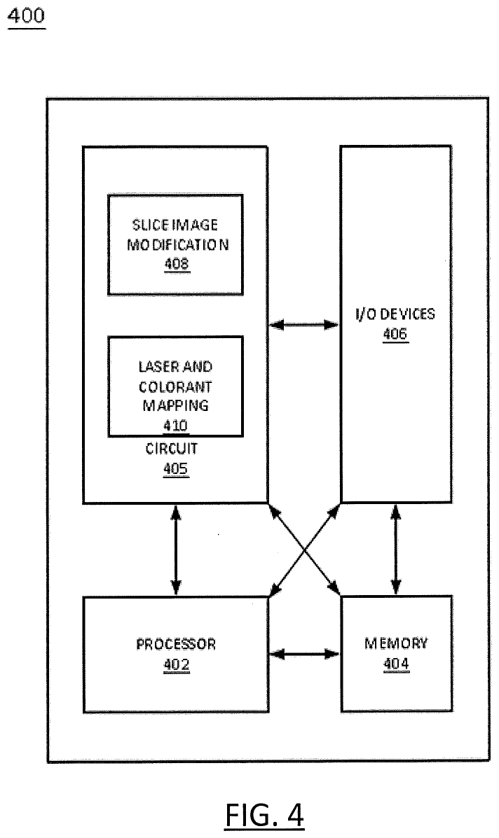

FIG. 4 depicts a high-level block diagram of an example computer that can be transformed into a machine capable of performing the functions described herein. Notably, no computer or machine currently exists that performs the functions as described herein. As a result, the examples of the present disclosure modify the operation and functioning of the general-purpose computer to perform additive manufacturing using fusing and non-fusing printing fluids, as disclosed herein.

As depicted in FIG. 4, the computer 400 includes a hardware processor circuit 402, such as a central processing unit (CPU), a microprocessor, or a multi-core processor, a memory 404, such as random access memory (RAM) and/or read only memory (ROM), a circuit 405 for performing additive manufacturing using laser 140, and various input/output devices 406, storage devices, including but not limited to, a tape drive, a floppy drive, a hard disk drive or a compact disk drive, a receiver, a transmitter, a speaker, a display, a speech synthesizer, an output port, an input port and a user input device, such as a keyboard, a keypad, a mouse, a microphone, and the like. Although one processor element is shown, it should be noted that the general-purpose computer may employ a plurality of processor elements. Furthermore, although one general-purpose computer is shown in the figure, if the method(s) as discussed above is implemented in a distributed or parallel manner for a particular illustrative example, i.e., the blocks of the above method(s) or the entire method(s) are implemented across multiple or parallel general-purpose computers, then the general-purpose computer of this figure is intended to represent each of those multiple general-purpose computers. Furthermore, a hardware processor can be utilized in supporting a virtualized or shared computing environment. The virtualized computing environment may support a virtual machine representing computers, servers, or other computing devices. In such virtualized virtual machines, hardware components such as hardware processors and computer-readable storage devices may be virtualized or logically represented.

It should be noted that the present disclosure can be implemented by machine readable instructions and/or in a combination of machine readable instructions and hardware, such as using application specific integrated circuits (ASIC), a programmable logic array (PLA), including a field-programmable gate array (FPGA), or a state machine deployed on a hardware device, a general purpose computer or any other hardware equivalents, such as computer readable instructions pertaining to the method(s) discussed above can be used to configure a hardware processor to perform the blocks, functions and/or operations of the above disclosed methods.

Thus, it will be appreciated that the present disclosure provides implementations of non-transitory machine readable media storing instructions executable by a processor circuit, such as circuit 110, to control an apparatus, such as 100 described above, including a first dispenser, a second dispenser, and a laser, such coupled to the processor circuit, wherein the instructions, when executed by the processor circuit, cause the processor circuit to practice any of the additive manufacturing methods set forth herein. For example, such instructions can cause the processor circuit to deposit a layer of sinterable material by way of the first dispenser, deposit colorant on the layer of sinterable material by way of the second dispenser, and fuse the layer of sinterable material using the laser. Among other alternatives, in some implementations, the instructions, when executed by the processor circuit, may cause the processor circuit to deposit the colorant using a halfloning technique. The machine readable instructions can similarly generate a model (including, for example, a slice image) that includes an object to be fabricated. The regions of the model defining the object to be fabricated are subsequently fabricated using the system 100.

In one example, instructions and data for the present module or process 405 for performing additive manufacturing using fusing laser 140, machine readable instructions can be loaded into memory 404 and executed by hardware processor circuit 402 to implement the blocks, functions or operations as discussed above in connection with the method 200. For instance, the circuit 405 may include machine readable instructions, including a slice image modification circuit 408 and a colorant distribution mapping circuit and/or laser mapping circuit 410.

The colorant and/or laser distribution mapping component 410 may be configured to generate a colorant or laser distribution map for a pass of an additive manufacturing process, based on a slice image having areas that are and that are not to be fused by the laser 140.

Furthermore, when a hardware processor executes instructions to perform various operations, this can include the hardware processor performing the operations directly and/or facilitating, directing, or cooperating with another hardware device or component, such as a co-processor and the like, to perform the operations.

The processor circuit executing the machine readable instructions relating to the above described method(s) can be a programmed processor or a specialized processor. As such, the present circuit 405 for performing additive manufacturing, including associated data structures, of the present disclosure can be stored on a tangible or physical (broadly non-transitory) computer-readable storage device or medium, such as volatile memory, non-volatile memory, ROM memory, RAM memory, magnetic or optical drive, device or diskette and the like. More specifically, the computer-readable storage device may include any physical devices that provide the ability to store information such as data and/or instructions to be accessed by a processor or a computing device such as a computer or an application server.

Terms to exemplify orientation, such as upper/lower, left/right, top/bottom and above/below, may be used herein to refer to relative positions of elements as shown in the figures. It should be understood that the terminology is used for notational convenience and that in actual use the disclosed structures may be oriented different from the orientation shown in the figures. Thus, the terms should not be construed in a limiting manner.

The skilled artisan would recognize that various terminology as used in the Specification (including claims) connote a plain meaning in the art unless otherwise indicated. As examples, the Specification describes and/or illustrates aspects useful for implementing the claimed disclosure by way of various structure, such as circuits or circuitry selected or designed to carry out specific acts or functions, as may be recognized in the figures or the related discussion as depicted by or using terms such as blocks, modules, device, system, unit, controller, and/or other examples.

It will also be appreciated that certain of these blocks may also be used in combination to exemplify how operational aspects (such as steps, elements, functions, activities, etc.) have been designed, arranged. Whether alone or in combination with other such blocks (or circuitry including discrete circuit elements such as transistors, resistors etc.), these above-characterized blocks may be circuits configured/coded by fixed design and/or by (re)configurable circuitry (such as, CPUs/logic arrays/controllers) and/or circuit elements to this end of the corresponding structure carrying out such operational aspects. In certain embodiments, such a programmable circuit refers to or includes a computer circuit, including memory circuitry for storing and accessing a set of program code to be accessed/executed as instructions and/or (re)configuration data to perform the related operation, as may be needed. Depending on the data-processing application, such instructions (and/or configuration data) can be configured for implementation in logic circuitry, with the instructions (via fixed circuitry, limited group of configuration code, or instructions characterized by way of object code, firmware and/or software) as may be stored in and accessible from a memory (circuit).

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve elements carried out in various orders, with aspects of the embodiments herein retained, or may involve fewer or more elements. Such modifications do not depart from the true spirit and scope of various aspects of the disclosure, including aspects set forth in the claims

What is claimed is:

1. A method comprising:
depositing colorant on a first layer of sinterable material; and
fusing the first layer of sinterable material using a laser to create a first layer of a three-dimensional object.

2. The method of claim 1, further comprising:
depositing a second layer of sinterable material onto the first layer of the three-dimensional object;
depositing colorant on the second layer of sinterable material; and
fusing the second layer of sinterable material using the laser to form a second layer of the three dimensional object.

3. The method of claim 2, further comprising repeating the depositing of sinterable material, the depositing of colorant, and the fusing of sinterable material to form the three dimensional object.

4. The method of claim 2, wherein depositing the colorant is accomplished at a voxel level in order to achieve a predetermined three dimensional color distribution in the three dimensional object.

5. The method of claim 4, wherein depositing the colorant is accomplished in a selective manner based on a predetermined geometry of the three dimensional object to be formed.

6. The method of claim 1, wherein the colorant is deposited using a halftoning technique.

7. The method of claim 1, wherein depositing the sinterable material is accomplished at a voxel level in order to achieve a predetermined three dimensional color distribution in the three dimensional object.

8. The method of claim 1, wherein fusing the first layer of sinterable material using the laser occurs after depositing the colorant.

9. The method of claim 1, wherein fusing the first layer of sinterable material using the laser occurs before depositing the colorant.

10. The method of claim 1, wherein fusing the first layer of sinterable material using the laser occurs concurrently with depositing the colorant.

11. The method of claim 1, wherein the colorant is free of a fusing agent material.

12. An apparatus comprising:
a processor circuit;
a first dispenser coupled to the processor circuit to deposit a layer of sinterable material;
a second dispenser coupled to the processor circuit to deposit colorant on the layer of sinterable material; and
a laser coupled to the processor circuit to scan across and to fuse the layer of sinterable material.

13. The apparatus of claim 12, wherein the laser includes a linear array of lasers mounted on a translatable head to scan across the layer of sinterable material.

14. A non-transitory machine readable medium storing instructions executable by a processor circuit to control an apparatus including a first dispenser, a second dispenser, and a laser coupled to the processor circuit, wherein the instructions, when executed by the processor circuit, cause the processor circuit to:
deposit a layer of sinterable material by way of the first dispenser;
deposit colorant on the layer of sinterable material by way of the second dispenser; and
fuse the layer of sinterable material using the laser.

15. The non-transitory machine readable medium of claim 14, wherein the instructions, when executed by the processor circuit, cause the processor circuit to deposit the colorant using a halftoning technique.
